(19) United States
(12) Patent Application Publication
(10) Pub. No.: US 2012/0145391 A1
(43) Pub. Date: Jun. 14, 2012

(54) COMPOSITIONS AND METHODS FOR WELL COMPLETIONS

(76) Inventors: Tatiana Pyatina, Bures Sur Yvette (FR); Sylwia Komocki, Chatenay Malabry (FR)

(21) Appl. No.: 12/964,837

(22) Filed: Dec. 10, 2010

(51) Int. Cl. E21B 33/00; C09K 8/487

(52) U.S. Cl. 166/285; 106/607; 523/130

(57) ABSTRACT

Well-cementing compositions for use in high-pressure, high-temperature (HPHT) wells usually contain a complex array of cement additives, including retarders, dispersants and fluid-loss additives. Under these extreme conditions additive degradation, reactions between additives, reactions between additives and the cement, or combinations thereof may occur—causing slurry gelation, premature setting or both. Incorporation of polyvalent-metal salts in the cement compositions can help prevent or reduce the severity of slurry gelation, setting-time reduction or both.

### BACKGROUND

The statements in this section merely provide background information related to the present disclosure and may not constitute prior art.

This invention relates to compositions and methods for treating subterranean formations, in particular, compositions and methods for cementing subterranean wells.

During the construction of subterranean wells, it is common, during and after drilling, to place a tubular body in the wellbore. The tubular body may comprise drillpipe, casing, liner, coiled tubing or combinations thereof. The purpose of the tubular body is to act as a conduit through which desirable fluids from the well may travel and be collected. The tubular body is normally secured in the well by a cement sheath. The cement sheath provides mechanical support and hydraulic isolation between the zones or layers that the well penetrates. The latter function is important because it prevents hydraulic communication between zones that may result in contamination. For example, the cement sheath blocks fluids from oil or gas zones from entering the water table and polluting drinking water. In addition, to optimize a well's production efficiency, it may be desirable to isolate, for example, a gas-producing zone from an oil-producing zone. The cement sheath achieves hydraulic isolation because of its low permeability. In addition, intimate bonding between the cement sheath and both the tubular body and borehole is necessary to prevent leaks.

Optimal cement-sheath placement often requires that the cement slurry contains a retarder, a dispersant and a fluid-loss additive. Cement retarders delay the setting of the cement slurry for a period sufficient to allow slurry mixing and slurry placement in the annular region between the casing and the borehole wall, or between the casing and another casing string. Dispersants help maintain the proper rheological properties of the cement slurry, promoting optimal fluid displacement—especially in long, narrow annuli. Fluid-loss additives help prevent the fluid phase of the cement slurry from escaping into the formation, leaving the solids behind.

A wide range of chemical compounds may be employed as cement retarders. The most common classes include lignosulfonates, cellulose derivatives, hydroxycarboxylic acids, saccharide compounds, organophosphonates and certain inorganic compounds such as sodium chloride (in high concentrations) and zinc oxide. A more complete discussion of retarders for well cements may be found in the following publication—Nelson E B, Michaux M and Drochon B: “Cement Additives and Mechanisms of Action,” in Nelson E B and Guillot D. (eds.): Well Cementing (2^{nd} Edition), Schlumberger, Houston (2006) 49-91.

Certain types of retarders may be blended with other compounds to extend their useful temperature range, improve cement-slurry properties, or both. For example, the useful temperature range of certain lignosulfonate retarders may be extended to more than 260° C. by adding sodium tetraborate decahydrate (borax). Sodium gluconate may be blended with a lignosulfonate and tartaric acid to improve the rheological properties of the cement slurry. The useful temperature range of organophosphonate retarders may also be extended to more than 260° C. by adding borate compounds. For well cementing, the most common dispersants are generally sulfonated aromatic polymers such as polynaphthalene sulfonate, polymelamine sulfonate and polystyrene sulfonate. Fluid-loss additives for well cements include water-soluble polymers such as polysaccharides (e.g., hydroxyethylcellulose), polyamines, polyvinylalcohols, and polyacrylates. Particulates such as bentonite, crosslinked polyvinylalcohols and latexes are also common. Thus, a myriad of retarders, retarder blends, dispersants and fluid-loss additives exist which may be applicable to a wide range of subterranean-well conditions.

When cementing high-pressure, high-temperature (HPHT) wells, the cement-slurry design may be complex, involving several additives that must be mutually compatible in order to achieve a successful cement job. In general, the well-cementing industry considers HPHT wells to begin at 150° C. (300° F.) bottomhole temperature and 69 MPa (10,000 psi) bottomhole pressure. The additives must remain stable at temperatures that may exceed 260° C. for a period sufficient to at least allow proper cement-slurry placement. Additive decomposition during placement may have undesirable consequences, including slurry gelation (strong viscosity increase) and premature setting. Similarly, reactions between additives may also cause rheological difficulties.

Under HPHT conditions, undesirable interactions between the additives and the cement become more likely. Such interactions may, in some cases, result in shorter thickening times, compromised performance of some additives (e.g. fluid-loss-control agents) and gelation problems (often referred to as a “quaternary gel”). The severity of such problems is strongly cement dependent.

Despite the valuable contributions of the prior art, there remains a need for means to prevent gelation, premature setting, or both in Portland-cement slurries at temperatures up to and exceeding 260° C.

### SUMMARY

Embodiments allow such improvements by providing cement additives that stabilize the rheological properties of Portland-cement slurries exposed to a HPHT environment.

In an aspect, embodiments relate to well-cementing compositions.

In a further aspect, embodiments relate to methods for controlling the rheological properties, the setting time, or both of a cement slurry.

In yet a further aspect, embodiment relate to methods for cementing a subterranean well.

### BRIEF DESCRIPTION OF THE DRAWINGS

FIG. 1 shows two thickening-time traces that illustrate the effect of sodium zirconium lactate on cement-slurry behavior at 260° C. and 203 MPa pressure.

### DETAILED DESCRIPTION

At the outset, it should be noted that in the development of any such actual embodiment, numerous implementation—specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range. All ratios or percentages described here after are by weight unless otherwise stated.

As stated earlier, there is a need for means by which cement-slurry gelation, premature setting, or both, may be prevented when cementing HPHT wells. The inventors have surprisingly discovered that polyvalent-metal-salts are useful for stabilizing the rheological properties of Portland-cement slurries, preventing premature setting, or both. Furthermore, adequate fluid-loss control is preserved.

In an aspect, embodiments relate to well-cementing compositions that comprise water, Portland cement, one or more polyvalent-metal salts, one or more retarder compounds, one or more borate compounds and at least one fluid-loss additive. The composition may also be pumpable. Those skilled in the art will recognize that a pumpable cement slurry usually has a viscosity lower than 1000 mPa-s at a shear rate of 100 s⁻¹.

In a further aspect, embodiments relate to methods for controlling the rheological properties, setting time or both of a cement slurry. A cement slurry is provided that comprises water and Portland cement. Incorporated into the slurry are one or more polyvalent-metal salts, one or more retarder compounds, one or more borate compounds and at least one fluid-loss additive.

In yet a further aspect, embodiments relate to methods for cementing subterranean wells. A cement slurry is provided that comprises water and Portland cement. Incorporated into the slurry are one or more polyvalent-metal salts, one or more retarder compounds, one or more borate compounds and at least one fluid-loss additive. The slurry comprising the polyvalent-metal salts, retarder and borate compounds, and at least one fluid-loss additive, is placed in the well. Those skilled in the art will recognize that the methods may pertain to both primary and remedial cementing operations.

For all embodiments, the polyvalent-metal salts may comprise one or more cations selected from the group comprising Fe²⁺, Fe³⁺, Al³⁺, Ti⁴⁺, Zn²⁺, Sn⁴⁺, Ca²⁺, Mg²⁺, Cr³⁺ and Zr⁴⁺. Of these, the Zr⁴⁺ salts are preferred. Sodium zirconium lactate is particularly preferred. The polyvalent-metal-salt molar concentration is preferably between about 0.2-3.0 M, and more preferred concentration range lies between 0.5-2.0 M.

For all embodiments, the retarder compounds may comprise a copolymer of styrene sulfonate and maleic acid, one or more organophosphonate compounds, or a combination thereof. The organophosphonate compounds may be chosen from the list comprising amino trimethylene phosphonic acid; 1-hydroxyethylidene-1,1,-disphosphonic acid; ethylene diamine tetramethylene phosphonic acid, hexamethylenediamine methylene phosphonic acid, diethylene triamine pentamethylene phosphonic acid; polyamino phosphonic acid, 2-phosphono-butane-tricarboxylic acid-1,2,4; bis(hexamethylene triamine pentamethylene phosphonic acid) and salts thereof, or mixtures thereof. Of these, the pentasodium salt of ethylene diamine tetramethylene phosphonic acid (EDTMP) is preferred. The retarder concentration is preferably between about 0.1% and about 1.5% by weight of solids in the slurry. This concentration scheme is commonly called “by weight of blend,” and will hereinafter appear as the abbreviation “BWOB.” The organophosphonate concentration in the slurry is preferably between about 0.02% and 0.4% BWOB. The concentration of the copolymer of styrene sulfonate and maleic acid is preferably between about 0.5% and about 1.5% BWOB.

For all embodiments, the borate compounds may comprise boric acid, sodium metaborate, potassium metaborate, sodium diborate, potassium diborate, sodium triborate, potassium triborate, sodium tetraborate, potassium tetraborate, sodium pentaborate, and potassium pentaborate, or mixtures thereof. These compounds may be anhydrous or contain waters of hydration. Of these, sodium tetraborate, potassium tetraborate, sodium pentaborate and potassium pentaborate are preferred. Sodium pentaborate is most preferred. The concentration of the borate compound is preferably between about 0.5% and 2.5% BWOB.

For all embodiments, the fluid-loss additive preferably comprises a copolymer of 2-Acrylamido-2-methylpropane sulfonic acid (AMPS) and acrylamide, a copolymer of AMPS and acrylic acid, or both. The concentration of the fluid-loss additive is preferably between about 0.2% and about 1.0% BWOB or, if in liquid form, between about 16.7 L/tonne and about 83.5 L/tonne of cement slurry. A suitable fluid-loss additive is the copolymer disclosed in U.S. Pat. No. 6,277,900.

For all embodiments, the cement compositions may further comprise more additives such as (but not limited to) extenders, lost-circulation additives, additives for improving set-cement flexibility, chemical-expansion agents, self-healing additives, antifoam agents, gas generating additives and anti-settling agents.

### EXAMPLES

The following examples serve to further illustrate the invention.

For all examples, cement-slurry preparation, thickening-time measurements and fluid-loss measurements were performed according to procedures published in ISO Publication 10426-2. Fluid-loss measurements were performed with a stirred fluid-loss cell.

Cement slurries were prepared with a blend that contained 33% by volume of blend (BVOB) Portland cement (Dyckerhoff Black Label Class G), 10% BVOB fine silica (CEMPLUS GEO Microfine Silica, available from Imextco, Singapore), 7% BVOB medium-size hematite (PMR300, available from Plomp Mineral Services, The Netherlands), 9% BVOB manganese tetraoxide (Micromax FF, available from Elkem Chemicals, Inc.), and 41% BVOB coarse silica (LG50, available from Plomp Mineral Services).

Compared to the other materials in the blend, the cement has a medium particle size. Therefore, the blend contained approximately 41% BVOB coarse particles, 40% BVOB medium-size particles and 19% BVOB fine particles.

To minimize foaming during cement-slurry mixing, 4.2 L/tonne of silicone antifoam agent were added to all slurries. In some cases, bentonite was added to help prevent solids sedimentation or the development of free fluid in the slurries when exposed to high temperatures.

A fluid-loss-control additive was incorporated into all slurries—a high-molecular-weight copolymer of AMPS and acrylamide (UNIFLAC™ Liquid, available from Schlumberger). The retarder formulation contained two materials: (1) an aqueous solution containing sodium pentaborate and pentasodium EDTMP (weight ratio: 6.7); (2) a copolymer of styrene sulfonate and maleic acid (molar ratio=1) (Narlex D-72, available from ALCO Chemical).

For most examples, the polyvalent-metal salt was sodium zirconium lactate. The salt was present in a solution with the following composition: 22.6 wt % sodium zirconium lactate, 13.6 wt % methanol and 63.8 wt % water. Solid magnesium sulfate (99% purity) was used in one of the examples.

The cement slurries were prepared at a solid-volume-fraction of 0.59 to 0.61, depending upon the additive concentrations. The slurry densities varied slightly, but were always close to 2277 kg/m³ (19 lbm/gal). Liquid additives were added to the mix fluid (tap water), and solid additives were dry blended with the cement.

Thickening times were measured with a pressurized consistometer rotating at 150 RPM. The initial hydrostatic pressure in the consistometer was 13.8 MPa (2000 psi), and the final hydrostatic pressures varied between 140 MPa (20,300 psi) and 203 MPa (29,500 psi). Experiments were conducted at two final temperatures: 260° C. (500° F.) and 274° C. (525° F.), and the heat-up times to reach the final temperatures were 90 min and 105 min and 130 min, respectively. The thickening time corresponds to the time necessary to reach 100 Bearden units (Bc).

Fluid-loss tests were performed in a stirred fluid-loss cell. The test-temperature ramp was the same as that for the thickening-time tests. After reaching the test temperature, the slurries were stirred an additional 10 minutes before beginning the fluid-loss-rate measurements.

### Example 1

Seven cement slurries were prepared, the compositions of which are presented in Table 1. Solid-additive concentrations are given by weight of solid blend (BWOB) The slurries were designed with two different batches of Class G cement (Designs 1-3 for one batch, Designs 4-7 for the other batch).

Thickening times were measured at 260° F. (500° F.). As shown by Designs 1 and 2, adding the fluid-loss-control agent shortened the thickening time. However, as shown by Designs 3, 5, 6 and 7, adding sodium zirconium lactate lengthened the thickening times.

TABLE 1
Effect of Zr⁴⁺ Salt on Cement-Slurry Thickening Times

| Design # | 1 | 2 | 3 | 4 | 5 | 6 | 7 |
|---|---|---|---|---|---|---|---|
| Temperature (° C.) | 260 | | | | | | |
| Class G cement | Batch 1 | | | Batch 2 | | | |
| Bentonite (% BWOB) | 1 | 1 | 1 | 1.5 | 1.5 | 1.5 | 1.5 |
| Retarder (L/tonne) | 49.2 | 49.2 | 49.2 | 49.2 | 49.2 | 49.2 | 59.2 |
| Dispersant (% BWOB) | 1 | 1 | 1 | 1 | 1 | 1 | 1 |
| Fluid-loss-control | — | 33.4 | 33.4 | 33.4 | 33.4 | 33.4 | 33.4 |
| Additive (L/tonne) | | | | | | | |
| NaZr lactate (L/tonne) | — | — | 1.67 | — | 1.67 | 3.34 | 1.67 |
| Thickening time | 28:03 | 17:28 | 30:44 | 7:38 | 9:42 | 12:25 | 22:48 |
| (hr:min) | | | | | | | |

### Example 2

The following series of experiments involved nine slurry designs. Thickening-time tests were performed at 260° C. and 274° C. All tests were performed at 203 MPa pressure. The results show that adding sodium zirconium lactate or magnesium sulfate to the cement formulations may prevent the occurrence of gelation, known as a quaternary gel. Such gels may adversely affect the operator's ability to achieve proper cement placement. The quaternary gels were detected during the thickening-time tests, and appeared as peaks on the thickening-time curve. Therefore, the magnitude of the gels is expressed in Bearden units (Bc).

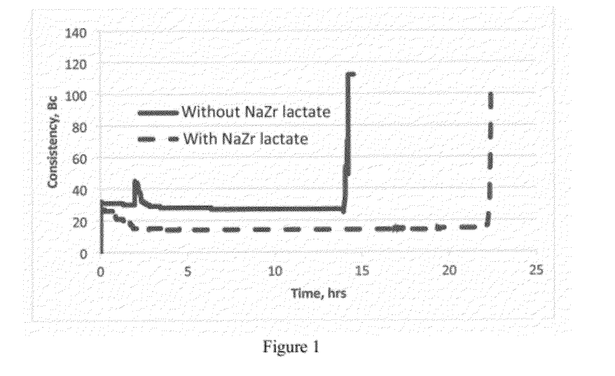

As shown in Table 2, strong quaternary gels were detected in slurries that did not contain a polyvalent-metal salt (Designs 8, 10, 12 and 15). The other slurries contained either sodium zirconium lactate or magnesium sulfate, and the quaternary gels did not appear. In addition, the thickening times were extended by the addition of sodium zirconium lactate. The behavior of Designs 8 and 9 is shown in FIG. 1.

TABLE 2
Effect of Polyvalent-Metal Salts on Cement-Slurry Thickening
Times and the Formation of Quaternary Gels.

| Design # | 8 | 9 | 10 | 11 | 12 | 13 | 14 | 15 | 16 |
|---|---|---|---|---|---|---|---|---|---|
| Temperature (° C.) | 260 | | | | 274 | | | | |
| Class G Cement | Batch 3 | | Batch 4 | | Batch 3 | | | Batch 4 | |
| Bentonite (% BWOB) | 0.8 | 0.8 | 0.8 | 0.8 | 0.8 | 0.8 | 0.8 | 0.8 | 0.8 |
| Retarder (% BWOB) | 0.68 | 0.68 | — | — | 0.68 | 0.68 | 0.68 | 0.68 | 0.68 |
| Dispersant (% BWOB) | 0.5 | 0.5 | 1 | 1 | 0.5 | 0.5 | 0.5 | 0.5 | 0.5 |
| Fluid-loss-control | 0.4 | 0.4 | — | — | 0.4 | 0.4 | 0.4 | 0.4 | 0.4 |
| additive (% BWOB) | | | | | | | | | |
| Fluid-loss control | — | — | — | — | — | — | — | — | — |
| additive (L/tonne) | — | — | 33.4 | 33.4 | — | — | — | — | — |
| NaZr lactate (L/tonne) | — | 3.75 | — | — | — | 3.75 | 4.17 | — | 3.3 |
| Mg SO₄ (% BWOB) | — | — | — | 0.045 | — | — | — | — | — |
| Thickening time (hr:min) | 14:14 | 22:25 | 17:30 | 14:00 | 9:59 | 10:18 | 14:15 | 1:42 | 12:15 |
| Consistency peak, Bc | 44 | — | 53 | — | 44 | — | — | 98 | — |

### Example 3

The fluid-loss behavior of six slurry designs was tested. The results, shown in Table 3, show that adding NaZr lactate did not have a detrimental effect on fluid-loss control.

TABLE 3
Effect of Zr⁴⁺ Salt on Cement-Slurry Fluid-Loss Control.

| Design # | 17 | 18 | 19 | 20 | 21 | 22 |
|---|---|---|---|---|---|---|
| Temperature (° C.) | 260 | | | | | 274 |
| Class G Cement | Batch 2 | | | Batch 3 | | Batch 4 |
| Bentonite (% BWOB) | 1.5 | 1.5 | 1.5 | 0.8 | 0.8 | 0.8 |
| Retarder (L/tonne) | 49.2 | 49.2 | 59.2 | — | — | — |
| Retarder (% BWOB) | — | — | — | 0.68 | 0.68 | 0.68 |
| Dispersant (% BWOB) | 1 | 1 | 1 | 0.5 | 0.5 | 0.5 |
| Fluid-loss control | 33.4 | 33.4 | 33.4 | — | — | — |
| additive (L/tonne) | | | | | | |
| Fluid-loss control | — | — | — | 0.4 | 0.4 | 0.4 |
| additive (% BWOB) | | | | | | |
| NaZr lactate (L/tonne) | — | 3.34 | 1.67 | — | 3.75 | 4.17 |
| API Fluid Loss mL/ | 45 | 56 | 26 | 22 | 28 | 29 |
| 30 min at BHCT | | | | | | |

1. A well-cementing composition, comprising water, Portland cement, one or more polyvalent-metal salts, one or more retarders, one or more borate compounds and at least one fluid-loss additive.

2. The composition of claim 1, wherein the polyvalent-metal salts are derived from one or more cations in the list comprising: Fe²⁺, Fe³⁺, Al³⁺, Ti⁴⁺, Zn²⁺, Sn⁴⁺, Ca²⁺, Mg²⁺, Cr³⁺ and Zr⁴⁺.

3. The composition of claim 1, wherein the retarder comprises a copolymer of styrene sulfonate and maleic acid, one or more organophosphonate compounds, or both; wherein the organophosphonate compounds are chosen from the list comprising: amino trimethylene phosphonic acid; 1-hydroxyethylidene-1,1,-disphosphonic acid; ethylene diamine tetramethylene phosphonic acid, hexamethylenediamine methylene phosphonic acid, diethylene triamine pentamethylene phosphonic acid; polyamino phosphonic acid, 2-phosphono-butane-tricarboxylic acid-1,2,4; bis(hexamethylene triamine pentamethylene phosphonic acid) and salts thereof.

4. The composition of claim 1, wherein the fluid-loss additive comprises a copolymer of AMPS and acrylamide, a copolymer of AMPS and acrylic acid, or both.

5. The composition of claim 1, wherein the borate compounds comprise boric acid, sodium metaborate, potassium metaborate, sodium diborate, potassium diborate, sodium triborate, potassium triborate, sodium tetraborate, potassium tetraborate, sodium pentaborate, and potassium pentaborate, or mixtures thereof.

6. The composition of claim 1, wherein the polyvalent-metal-salt molar concentration is between about 0.2 M and 3.0 M.

7. The composition of claim 1, wherein the borate-compound concentration is between about 0.5% and about 2.5% by weight of blend.

8. The composition of claim 1, wherein the retarder concentration is between about 0.1% and about 1.5% by weight of blend.

9. The composition of claim 1, wherein the fluid-loss-additive concentration is between about 0.2% and about 1.0% by weight of blend.

10. A method for controlling the rheological properties, the setting time, or both of a cement slurry, comprising:
(i) providing a cement slurry comprising water and Portland cement; and
(ii) incorporating one or more polyvalent-metal salts, one or more organophosphonate compounds and one or more borate compounds in the slurry.

11. The method of claim 10, wherein the polyvalent-metal salts are derived from one or more cations in the list comprising: Fe²⁺, Fe³⁺, Al³⁺, Ti⁴⁺, Zn² Sn⁴⁺, Ca²⁺, Mg²⁺, Cr³⁺ and Zr⁴⁺.

12. The method of claim 10, wherein the retarder comprises a copolymer of styrene sulfonate and maleic acid, one or more organophosphonate compounds, or both; wherein the organophosphonate compounds are chosen from the list comprising: amino trimethylene phosphonic acid; 1-hydroxyethylidene-1,1,-disphosphonic acid; ethylene diamine tetramethylene phosphonic acid, hexamethylenediamine methylene phosphonic acid, diethylene triamine pentamethylene phosphonic acid; polyamino phosphonic acid, 2-phosphono-butane-tricarboxylic acid-1,2,4; bis(hexamethylene triamine pentamethylene phosphonic acid) and salts thereof.

13. The method of claim 10, wherein the fluid-loss additive comprises a copolymer of AMPS and acrylamide, a copolymer of AMPS and acrylic acid, or both.

14. The method of claim 10, wherein the borate compounds comprise boric acid, sodium metaborate, potassium metaborate, sodium diborate, potassium diborate, sodium triborate, potassium triborate, sodium tetraborate, potassium tetraborate, sodium pentaborate, and potassium pentaborate, or mixtures thereof.

15. A method for cementing a subterranean well, comprising:
(i) providing a cement slurry comprising water and Portland cement;
(ii) incorporating one or more polyvalent-metal salts, one or more organophosphonate compounds and one or more borate compounds in the slurry; and
(iii) placing the slurry in the well.

16. The method of claim 15, wherein the polyvalent-metal salts are derived from one or more cations in the list comprising: Fe²⁺, Fe³⁺, Al³⁺, Ti⁴⁺, Zn²⁺, Sn⁴⁺, Ca²⁺, Mg²⁺, Cr³⁺ and Zr⁴⁺.

17. The method of claim 15, wherein the retarder comprises a copolymer of styrene sulfonate and maleic acid, one or more organophosphonate compounds, or both; wherein the organophosphonate compounds are chosen from the list comprising: amino trimethylene phosphonic acid; 1-hydroxyethylidene-1,1,-disphosphonic acid; ethylene diamine tetramethylene phosphonic acid, hexamethylenediamine methylene phosphonic acid, diethylene triamine pentamethylene phosphonic acid;
polyamino phosphonic acid, 2-phosphono-butane-tricarboxylic acid-1,2,4;
bis(hexamethylene triamine pentamethylene phosphonic acid) and salts thereof.

18. The method of claim 15, wherein the fluid-loss additive comprises a copolymer of AMPS and acrylamide, a copolymer of AMPS and acrylic acid, or both.

19. The method of claim 15, wherein the borate compounds comprise boric acid, sodium metaborate, potassium metaborate, sodium diborate, potassium diborate, sodium triborate, potassium triborate, sodium tetraborate, potassium tetraborate, sodium pentaborate, and potassium pentaborate, or mixtures thereof.

20. The method of claim 15, wherein the polyvalent-metal-salt molar concentration is between about 0.2 M and 3.0 M.
